(19) United States
(12) Patent Application Publication
(10) Pub. No.: US 2018/0315001 A1
(43) Pub. Date: Nov. 1, 2018

(54) AGENT PERFORMANCE FEEDBACK

(71) Applicant: HRB Innovations, Inc., Las Vegas, NV (US)

(72) Inventor: Brandon Garner, Gardner, KS (US)

(21) Appl. No.: 15/497,774

(22) Filed: Apr. 26, 2017

(51) Int. Cl. G06Q 10/06

(52) U.S. Cl. CPC G06Q 10/06398

(57) ABSTRACT

Media, method and system are described for creating and operating software capable of performing steps to provide an agent with feedback from a supervisor on current performance interacting with a client. Embodiments of the invention calculate values of performance metrics and assign each a weight contributing to an overall performance score. Embodiments of the invention further calculate the overall performance score and transmit it for presentation to the agent in such a way that a clear indication of success and/or desired change in performance can be easily understood.

### BACKGROUND

### 1. Field

Embodiments of the invention are broadly directed to methods and systems for creating software capable of performing steps to provide feedback of an agent's performance providing a weighted indication of success within a complex metric. Specifically, embodiments of the invention compose timely overall feedback regarding an agent's interaction with a client that may be smoothly adjusted to portray changing expectations and needs.

### 2. Related Art

Traditionally, feedback for agents conducting client calls and/or chats has been composed of raw values or statistics, such as an average number of minutes per call or total amount of money collected per week. While such data is useful and relevant, it often fails to communicate a clear evaluation of an agent's performance. Further, this type of simple feedback often leaves the agent unsure of how they might modify their performance to improve the quality of a client's future experiences or better meet their supervisor's expectations.

Further, traditional approaches to agent feedback often lack the ability to communicate a real-time evaluation of an agent's live performance, which would allow a supervisor to shape a relationship between an agent and a client smoothly and discreetly. Accordingly, there is a need for improved systems and methodologies to allow supervisors to manually and/or automatically compose feedback of an agent's performance that is weighted to communicate an overall performance score to the agent.

### SUMMARY

Embodiments of the invention address this need by evaluating a number of performance metrics based on measurable parameters recorded during a performance, such as a call or chat. Embodiments of the invention may further include steps of calculating a weight for each performance metric, by which an overall performance score is calculated and transmitted to the agent as an indication of performance success. Embodiments of the invention display this overall performance feedback using various techniques and periodicities.

In a first embodiment, a computer-readable medium stores computer-executable instructions which, when executed by a processor, perform a method of composing feedback in which a set of measurable parameters is recorded during a first performance by a set of agents for assessment. Next, a plurality of performance metrics are evaluated based this set of measurable parameters. A weight for each of the performance metrics is calculated based at least in part on a second performance of a second set of agents to enable a calculation of an overall performance score. This second set of agents and second performance may be the same as or different from the first set of agents and first performance. The overall performance score is then sent to at least one of the set of agents for assessment. The calculated weights may be transmitted to the agent(s) along with the overall performance score(s). Particularly, the overall performance score may be calculated as a summation of a set of products of the values for each designated performance metric and the weights for each designated performance metric.

In a second embodiment, a computer-readable medium stores computer-executable instructions which, when executed by a processor, perform a method of composing feedback in which a plurality of performance metrics are designated to be applied to a live performance of a selected agent. A weight is calculated or each designated performance metric based at least in part on the needs, responses, actions, or other characteristics of the client being served by the agent during the live performance. A value for each performance metric is calculated based on the live performance, and an overall performance score is then calculated based on these values and the weight assigned to for each. The overall performance score may then be transmitted as feedback to the agent for assessment, in some cases along with an indication of a change in the overall performance score over time. The weights calculated for each performance metric may be based in part on the client being served during the performance.

In a third embodiment, a computer-readable medium stores computer-executable instructions which, when executed by a processor, perform a method of composing feedback in which a plurality of performance metrics are designated to be applied to a live performance of a selected agent. A weight is calculated or each designated performance metric based at least in part on a set of prior performances of a set of agents for comparison, such as a role or specialty of agents. A value for each performance metric is calculated based on the live performance, and an overall performance score is then calculated based on these values and the weight assigned to for each. The overall performance score may then be transmitted as feedback to the agent for assessment.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts a first flowchart illustrating the operation of a method in accordance with an embodiment of the invention;

FIG. 3 depicts an example of feedback that may be presented to an agent in embodiments of the invention;

FIG. 4 depicts a second flowchart illustrating the operation of a method in accordance with an embodiment of the invention;

FIG. 5 depicts a third flowchart illustrating the operation of a method in accordance with an embodiment of the invention; and

FIG. 6 depicts a fourth flowchart illustrating the operation of a method in accordance with an embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

Embodiments of the invention are directed to media, methods, and systems for composing feedback for a performer, such as an agent conducting phone calls or chats, that presents a weighted representation of success of a performance. An exemplary performance is a client sales and collections call, which seeks to form, maintain, and/or improve a relationship with a client while collecting and/or increasing revenue. Alternatively, a performance may be a technical support chat, conducted primarily or entirely through text. These examples are not intended as limiting. Embodiments of the invention may be applied in any situation in which an agent interacting with a client may benefit from improved feedback from one or more superiors.

Traditionally, such feedback is provided to an agent as raw data, measured during a single performance or averaged over a period, such as the previous year. In some cases, feedback includes subjective survey data collected from clients at some point after the conclusion of the agent's interaction, immediately thereafter and/or periodically collected. While valuable, these types of feedback often lack context and may fail to provide the agent with a clear understanding of his strengths and weaknesses, successes and failures, and goals for which to aspire. Further, often traditional methods of composing and providing feedback are slow, only providing performance critiques to an agent well after a performance, such as an interaction with a client, has concluded.

Embodiments of the invention first address these issues by composing feedback in real time, and may provide such feedback to an agent while the performance being critiqued is happening. Feedback may be provided in the form of an overall performance score, a unitless expression of a success level of an agent's interaction with a client. The overall performance score may indicate to the agent how a supervisor would judge their performance in a subjective manner using a set of objectively defined values and weights.

This feedback enables an agent to understand during a live performance (such as a verbal or textual client interaction) the goals that have been set, his or her relative accomplishment of those goals, and/or an evaluation of a superior (such as a supervisor) of their overall performance. Further, the feedback composed in embodiments of the invention may propose or suggest and what actions or adjustments may improve the agent's overall performance evaluation and satisfaction level of a client while an interaction is still happening and/or for future interactions.

As an example, consider the case of an agent, Jon Jones, conducting a sales call with a client of a software distributor. In the past, Jon has performed well on his average rate of successful sales and customer service rating, but his income per call is low and his average time per call is very high. When the call with the client (a performance) begins, Jon may be presented with feedback stating that his top goal for is to complete a sale of at least 100 dollars, with a secondary goal of keeping the total call time below twenty minutes. As the call progresses, Jon successfully completes a sale of 75 dollars, and continues to describe additional software modules available for purchase.

When the call reaches twelve minutes in length, feedback may adjusted automatically and presented to Jon that displays his top goal is now to keep the call time below twenty minutes, with a secondary goal of maintaining a high customer service rating after the call. Further, Jon may be presented with an overall performance score of 79 out of 100, informing him that he has performed well, but still has room for improvement. If, however, Jon completes his call in nineteen minutes and later receives a high customer satisfaction rating, the overall performance score may again be adjusted to a 92 out of 100, informing Jon that his performance on the client call was very good, though not perfect. Of course, any performance metrics or scale of overall performance score may be used in alternative embodiments. In some embodiments, the overall performance score may be calculated as a summation of the set of products of the values for each performance metric and the weights for each performance metric. The above example is exemplary, and is not intended as limiting in any way.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### OPERATIONAL ENVIRONMENT FOR EMBODIMENTS OF THE INVENTION

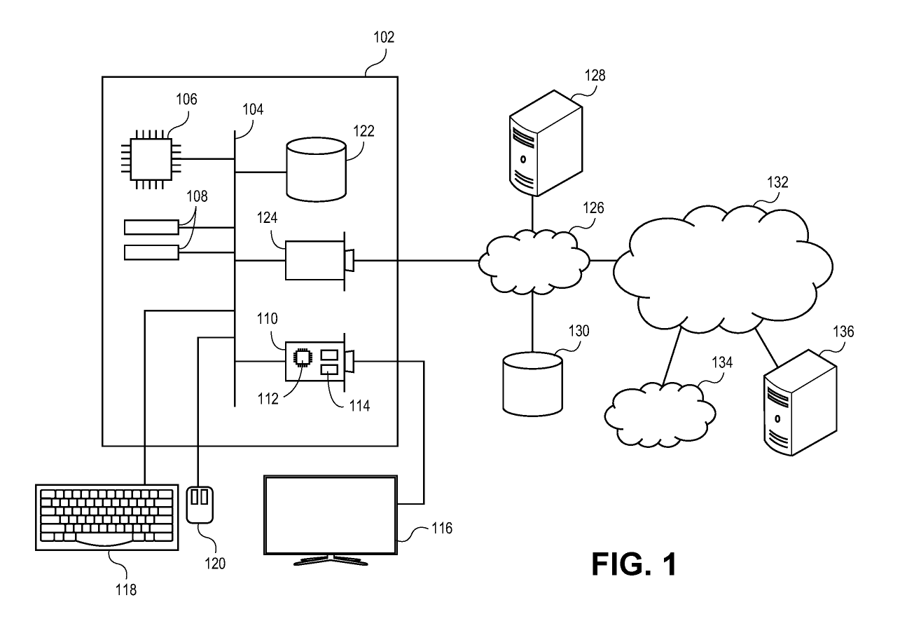

Turning first to FIG. 1, an exemplary hardware platform that for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 104 may not be a physically separate card, but rather may be integrated into the motherboard or the CPU 106.

In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments, no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Computer-readable media include both volatile and nonvolatile media, removable and non-removable media, and contemplate media readable by a database. For example, computer readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132. In some embodiments, steps of methods disclosed may be performed by a single processor 106, single computer 128, single memory 108, and single data store 130, or may be performed by multiple processors, computers, memories, and data stores working in tandem.

### OPERATION OF EMBODIMENTS OF THE INVENTION

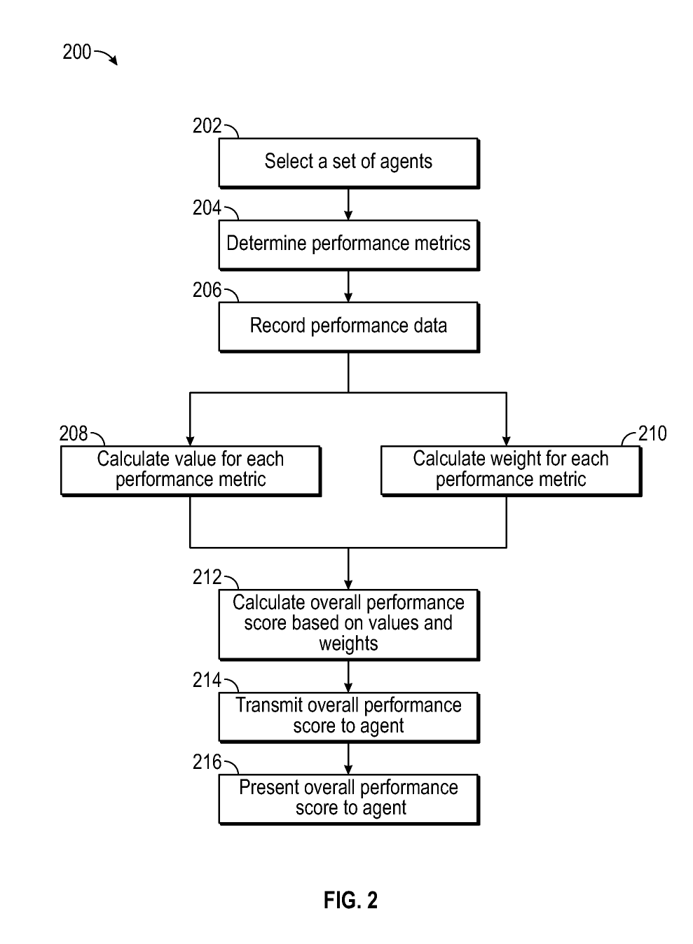

Illustrated in FIG. 2 is a method stored in computer-executable instructions on a non-transitory computer readable medium according to an embodiment of the invention beginning at step 202, in which a set of agents is selected for assessment. In embodiments, the set of agents selected may be a single agent, may be a set of agents selected by some defining attribute, may be all agents, or may be a randomly selected set. The set of agents for assessment may be selected by a processor 106 from the set of all agents, which may be stored in data store 130. Alternatively, the set of agents for assessment may be selected by a user such as a supervisor, in embodiments. Similarly, a set of available performance metrics may be stored in data store 130 for selection by a processor 106 in step 204. Examples of performance metrics that may be evaluated in embodiments of the invention include average time per call, average monetary amount collected per unit time, shrinkage, average rate of sales success, and a forecasted satisfaction rating. This list is intended only as exemplary, and is not intended to be limiting in any way.

At step 204, a plurality of performance metrics for evaluation of the set of agents selected for assessment is determined. Determination may be performed manually by a user, such as a supervisor, and/or automatically by processor 106. As further discussed below, determination of the performance metrics from the set of available performance metrics in step 204 may be performed based on user input, a current date or season, an agent's role, specialty, location, or department of one or more of the agents selected for assessment, and/or a client being served.

For example, the set of agents for assessment may be selected based on a role and location, such as all technical support agents at an office in Lexington, Ky. Processor 106 may then choose performance metrics of shrinkage, average time per call, and average working time per week to address a user-defined issue at that location of low productivity from the technical support staff. In an alternative example, a single user selected in step 202 may be compared across all performance metrics stored in data base 130. These are only two examples, each appropriate for a given situation, which are not intended to be limiting to the scope of the invention.

At step 206, a set of measurable parameters necessary for calculation of the designated performance metrics are recorded during a first performance of the first set of agents, and stored in memory 108 and/or database 130. Such a performance may be, for example, a telephone call or a text chat with a client such as a prospective customer, a subscriber, an insurance member, or a purchaser of a product. The value of each selected performance metric for every agent in the set of agents for assessment may then be calculated based on the recorded measurable parameters in step 208. Alternatively, in step 208 the value of each selected performance metric for the set of selected agents for assessment as a whole may be calculated and averaged based on the recorded parameters to evaluate an entire department, location, specialty, or role at once. In some embodiments, the value of a particular performance metric may simply equal the value of a particular measurable parameter, such as call length or dollars earned.

In an example, the first performance may be a chat between a tax professional agent and a subscriber of tax calculating and accounting software. Processor 106 may monitor the chat and record measurable parameters such as the words per minute typed by the agent and the subscriber, the length of the chat, keywords discussed, and the number of capital letters typed by the subscriber. From these measured parameters, performance metrics, such as a forecasted satisfaction rating of the subscriber, may be calculated by processor 106. Other performance metrics, such as the average length of chats by the selected agent or frequency of chats initiated by the subscriber may be calculated by processor 106 based on client data and/or prior recorded parameters retrieved from data store 130.

In alternative embodiments, the recording of measurable parameters in step 206 may occur before the determination of performance metrics in step 204. Such a configuration of steps would allow selection of performance metrics based on the particular set of measurable parameters recorded. Processor 106 would then proceed to calculate the value for each designated performance metric based on the recorded set of measurable parameters in step 208, as before.

In step 210, processor 106 calculates a weight for each of the performance metrics determined in step 204 for calculation of an overall performance score. Weights may be calculated, in embodiments, based on a client being served, a date or season, manual user input, a forecasted satisfaction rating of a client being served, and/or a second performance of a second set of agents. Weights may be calculated automatically by a processor 106 and/or may be manually set by a supervisor or administrator. In embodiments, the first set of agents and the second set of agents may be the same set of agents, or may be partially or wholly distinct. Similarly, in embodiments, the first performance may be the same as or distinct from the second performance.

Returning to the example of a chat between a tax professional agent and a subscriber of tax calculating and accounting software, following the calculation of the value of each designated performance metric in step 208, processor 106 may calculate a weight for each performance metric. The weighting is then calculated, in this example, based on previous data retrieved from data store 130 detailing previous interactions with the subscriber, particularly those conducted by the selected tax professional agent. Upon determining that this subscriber has, in previous interactions, chatted for a much longer length of time than average but has given a high satisfaction rating, processor 106 calculates a weight of 75% for a performance metric of call length, 20% for a dollar amount earned, and only 5% for a forecasted satisfaction rating. In another example, the processor 106 may determine that the interaction between the tax professional agent and the subscriber occurred or is occurring on a date that is during tax season, and would calculate a higher weight for minutes spent demonstrating software and a lower weight for length of call kept below a prescribed time threshold.

In step 212, the processor 106 performs the calculation of the overall performance score from the evaluated performance metrics and the calculated weights for each from steps 208 and 210, respectively. Particularly, in one embodiment this may be calculated as a summation of a set of products of the values for each designated performance metric and the weights calculated for each designated performance metric. In embodiments, the overall performance score may further be normalized in step 212 to a standard maximum, such as 100 points. The overall performance score is intended as a unitless expression of a success level of an agent's interaction with a client. While it may not directly measure any value, it may indicate to the agent how a supervisor would subjectively judge their performance without requiring the effort, time, and delay of a personal review.

In step 214, the calculated overall performance score is transmitted to the agent through any method, including but not limited to email, web portal, or directly through a dedicated application. In some embodiments, the set of designated performance metrics, calculated values of those metrics, and/or weight calculated for each designated performance metric may also be transmitted to the agent to provide context for how the overall performance score was calculated and how the agent may improve their score in the future.

In step 216, the overall performance score is presented to the agent via a display, along with any or all of the additional transmitted data described above. In embodiments, the overall performance score and/or additional data may be presented to the agent in any manner, such as through or including color coding, font, size, icons, sounds, vibrations, flashing, and/or positioning on the display. In some embodiments, transmitted performance metrics may be arranged in an ordered hierarchy, with the performance metrics with the highest calculated weight contribution towards the overall performance score arranged above those with lower calculated weights. Additional comments, automated suggestions for improvements, links to training materials, and or previous performance data may also be displayed and/or updated in step 216. For example, processor 106 may transmit the agent an indication of a change in the overall performance score over time in step 214, which is presented in step 216 as a new or updated line graph.

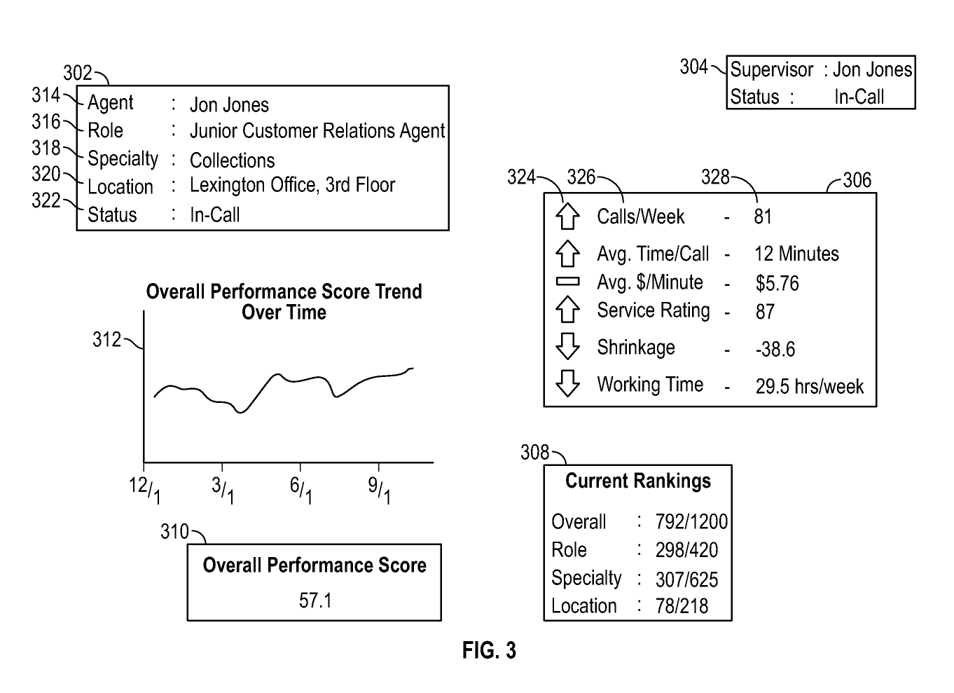

Turning now to FIG. 3, an example of feedback that may be transmitted and presented to an agent in embodiments of the invention is illustrated. Such feedback may be presented on any computing device, such as those described above with reference to computers 102, 128, or 136. The illustration of FIG. 3 including reference information 302, supervisor information 204, performance metric list 306, rankings list 308, overall performance score display 310, and line graph 312 is intended for example only, and is not intended as limiting. In embodiments, any of the elements illustrated may be differently arranged, shaped, sized, or may be omitted altogether. Additional elements not illustrated may be included in some embodiments.

Element 302 displays reference information regarding the agent using the computer displaying feedback screen 300, such as the agent's name 314, role 316, specialty 318, location 320, and status 322. In embodiments, a role 316 may be any function performed for a company or business, such as sales representative, technical support agent, senior tax advisor, or agent-in-training. Likewise, in embodiments, a specialty 318 may be any particular focus, concentration, or expertise of an agent, such as collections, customer relations, claims, or account management. In some embodiments, a specialty may indicate an agent's focus or expertise in a given software module for sale or support.

The agent location 320 may indicate an agent's building, floor, city, state, country, and/or region. The illustrated status 322 may indicate that an agent is in a call or chat, between performances, on a break, out of the office, or training. The reference information data including agent name 314, role 316, specialty 318, location 320, and status 322 may be stored in and retrieved from data store 130 and/or memory 108, and any or all of this information may be used for determining performance metrics and/or calculating weights.

Supervisor information 304 may also be used for determining performance metrics and/or calculating weights, in embodiments seeking to compare all agents under a particular supervisor. Supervisor information 304, as illustrated in FIG. 3, displays the name of the supervisor and their status, informing an agent as to which supervisor is present and whether or not they are observing the agent.

Performance metric list 306 illustrates a display of performance metrics that have been calculated for the agent and transmitted by processor 106. The set of performance metrics displayed may be set or variable, in embodiments. Each displayed performance metric 326 is listed with its calculated value 328 in a descending list from highest weight to lowest weight. Additionally, in some embodiments, icons 324 next to each performance metric 326 indicate the relative movement of the performance metric up or down the performance metric list 306. In other embodiments, the icons 324 may indicate an improvement or regression in a performance metric value relative to a goal threshold. Icons 324 may further be color coded to indicate success, failure, improvement, or regression for each performance metric.

Rankings list 308 displays a number of indications to an agent of his performance relative to other agents with shared attributes, such as role, location, or specialty. Rankings list 308 may update periodically, for instance every minute, hour, day, or week, or may update upon reception of every transmitted overall performance score. Like performance metric list 306, rankings list 308 may be displayed with icons indicating the agent's relative improvement or regression in rankings (not shown).

Overall performance score display 310 presents the overall performance score calculated by processor 106 to the agent, which may have been calculated for the most recent client chat or call performance. Alternatively, the overall performance score displayed may be a historical average, updated upon each performance to inform the agent of his or her performance. The overall performance score may be presented with flashing, coloring, icons, or any other appropriate indication of satisfaction of a supervisor, employer, or client of the agent's performance. In some embodiments, the weights calculated for each performance metric determined from the set of all performance metrics for evaluation of one or more agents may be displayed to the user along with overall performance score display 310, or elsewhere on feedback screen 300. Line graph 312 may display the changing trend in overall performance score over time, and/or may be configured by the user, supervisor, or an administrator to display the change in any selected performance metric over time.

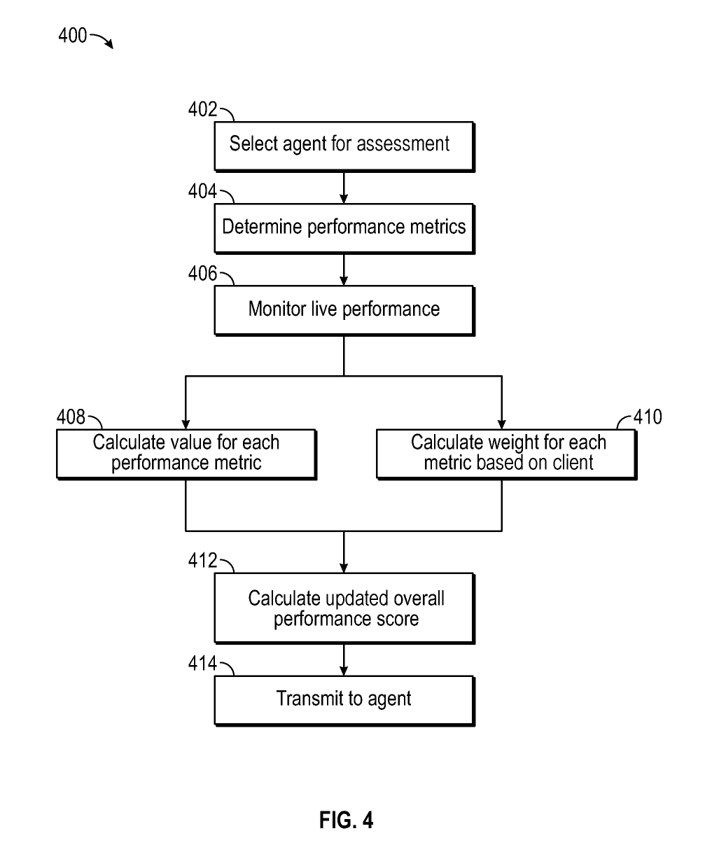

In embodiments, the set of agents selected for assessment may be a single agent, and the performance metrics designated from the set of performance metrics may be calculated based on a live performance. Such a method is illustrated in FIG. 4, beginning at step 402 in which an agent for assessment is selected. In embodiments, the agent may be selected manually by a supervisor or automatically by a processor 106. For instance, executed instructions could cause processor 106 initiate selection of an agent at periodic intervals, such as once per quarter, and/or automatically upon a prescribed number of performances, such as every tenth call.

In step 404, as in step 204 above, a set of performance metrics may be selected from available performance metrics stored in data store 130 for evaluation of the live performance of the selected agent by a processor 106. At step 406, a live performance, such as a call or chat between the selected agent and a client or customer is monitored by processor 106 and measurable parameters such as call length or dollars collected are recorded. The values of the measurable parameters may be stored in data store 130 for future retrieval. In step 408, the value of each selected performance metric from step 404 is calculated and may similarly be stored in data store 130.

In step 410, a weight is calculated for each of the performance metrics determined for evaluation of the performance in step 404. In this embodiment, the weights are calculated based, at least in part, on the client being served during the live performance. In step 412, an overall performance score is calculated using the performance metric values and respective weights based on the client. The overall performance score is then transmitted to the selected agent in step 414.

For example, a Sales Agent may interact with a regular customer of a medical supply delivery service. Based on data retrieved from data store 130 regarding prior interactions of all agents with this customer, processor 106 may find a correlation between successful sales and a speaking volume above 65 dB, perhaps because the customer has impaired hearing. Based on this data, a measured speaking volume above 65 dB may be weighted by the processor 106 in step 410 as a high contribution to the Sales Agent's overall performance score. In such an embodiment, the processor 106 may present to the Sales Agent a message indicating this goal and/or the Agent's current speaking volume to assist the agent in meeting this goal and maximizing their overall performance score.

In another example, the weight calculated for each designated performance metric may be calculated based at least in part on a satisfaction rating of the client forecasted by processor 106. For example, in a live chat performance, if a client beings typing in all capital letters or using obscenities, processor 106 may forecast a very low satisfaction rating of the client and calculate an overall performance score with a high weight attributed to satisfaction rating. A resulting low overall performance score with instructions to improve customer appeasement may be presented to the agent while the chat is still in process.

In embodiments that evaluate live performances, overall performance scores may be transmitted and presented to an agent while the live performance is underway. Such a methodology provides the agent with real time feedback of their performance, allowing the agent to modify their performance to improve their overall feedback score before the completion of the call or chat.

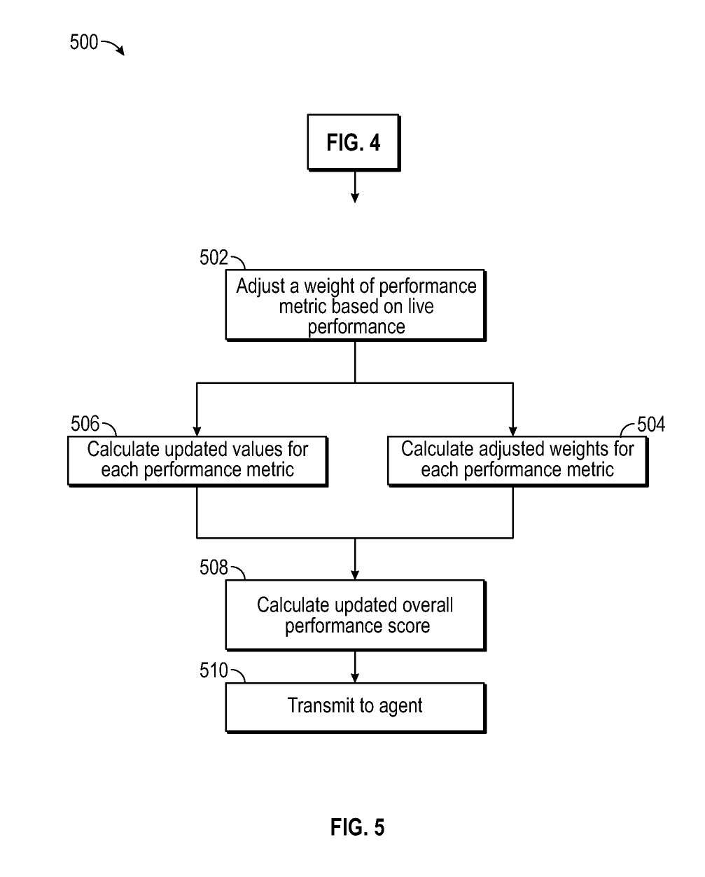

An example of such an embodiment is illustrated in FIG. 5, which continues the process of FIG. 4 from step 414. At step 502, at least one of the weights or values of performance metrics is adjusted to portray an updated goal for the ongoing interaction or a desired change in the agent's performance. Continuing the example above of a Sales Agent and regular customer, following the transmission of the first overall performance score to the agent in step 414 of FIG. 4, at least one weight may be adjusted by processor 106 and/or a supervisor. For example, a supervisor monitoring the call may determine that the customer is getting off-topic, and increase the weight of a performance metric that sets a goal of keeping shrinkage time below 15%. Additionally or alternatively, after a completed sale by the Sales Agent, processor 106 may reduce the weight of a performance metric measuring dollars earned for this performance.

In step 504, adjusted weights for each performance metric are calculated by processor 106. In embodiments, all performance metric weights may be adjusted to account for the change in the weight or weights adjusted in step 502. In other embodiments, only particular performance metric weights are adjusted in step 504.

In step 506, updated values for each performance metric are calculated based on the continued performance since the initial calculation in step 408. In alternative embodiments, the values for each performance metric may be calculated only for the agent's performance since the initial overall performance score transmission in step 414. In yet other embodiments, the initial performance metrics calculated in step 408 may be reused in the interest of time, simplicity, and/or computational resources. In step 412, an updated overall performance score is calculated by processor 106, which is then transmitted to the agent for an updated feedback display.

While the method illustrated in FIG. 5 for adjusting weights and/or values calculated for performance metrics has been described as an extension of the single agent live performance method of FIG. 4, this is not intended to be limiting. Such a method may be followed, in embodiments, for multi-agent and/or prior performance evaluations.

Another application of feedback methods of embodiments of the invention may be used to compare an agent's live performance to a prior performance of a set of agents that may or may not include the agent for assessment. This may be applied, for example, in situations where a new or struggling agent could benefit from comparison with the performances of seasoned, high-performing coworkers.

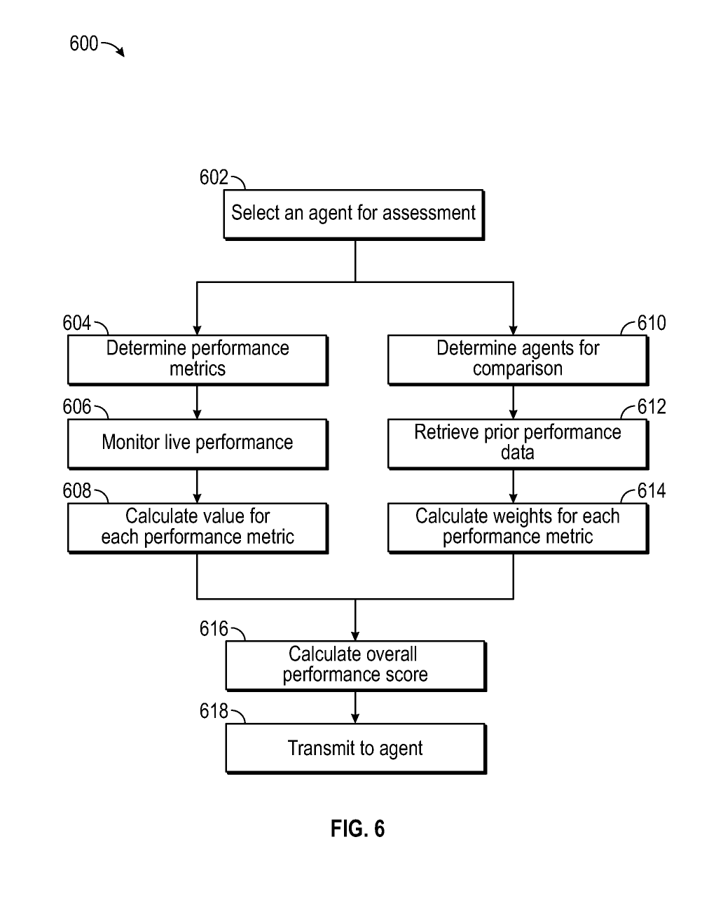

As illustrated in FIG. 6, method 600 of such an embodiment begins in step 602, wherein a processor 106 or supervisor selects an agent for assessment, as has been previously discussed. In step 604, a plurality of performance metrics for evaluating the performance of the agent is selected, as previously discussed. In step 606, the live performance of the agent, such as a live chat, is monitored and measurable parameters are recorded. In step 608, the measured parameters are used by processor 106 to calculated the values of each of the performance metrics selected in step 604.

Simultaneously or sequentially, in step 610, a processor 106 determines a set of agents and/or performances by those agents for comparison with the recorded metrics from the live performance of the selected agent. In embodiments, these agents may share an attribute with the selected agent, such as a role, location, specialty, previous ranking, previous overall performance score, or demographic characteristic. Alternatively, the set of agents for comparison may be all agents, randomly selected agents, the same agent, the highest performing agent or agents, the lowest performing agent or agents, or an average of any of the above. In another embodiment, the agents for comparison may be selected based on interaction with the client being served in the live performance by the selected agent.

In step 612, values for each of the designated performance metrics for prior performances of the set of agents for comparison are retrieved from data store 130. In step 614, weights are calculated for each of the designated performance metrics based at least in part on a set of prior performances of the set of agents for comparison. In step 616, the overall performance score is calculated using the performance metric values and respective weights, which are then transmitted to the agent for assessment in step 618.

For example, a live performance of a client call by a Junior Technical Support Associate may be monitored by a processor 106 and a Technical Support Associate Supervisor. Recorded performance metrics such as call length, volume of client voice, words used, tone of voice may be used by processor 106 to automatically calculate a forecasted satisfaction rating of the client for the call. Processor 106 may then select agents for comparison that had the highest satisfaction rating with this particular client, and may retrieve data from data store 130 detailing their performances. Thereafter, an overall performance score for the Junior Technical Support Associate may be calculated based at least in part on weights calculated from the prior performances of the agents selected for comparison. The overall performance score is then transmitted to the agent for feedback display.

In this example, as in the example described for FIG. 5 previously, feedback pertaining to a live performance may be presented to an agent before the completion of the performance. In some embodiments, the process of FIG. 6 may be performed repeatedly for the same performance to provide a running, real time display of feedback to an agent. In some embodiments, the process of FIG. 6 may be performed automatically in response to a button press by the agent or a supervisor to provide an updated overall performance score upon request.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable medium storing computer-executable instructions which, when executed, cause a processor to execute a method of composing feedback, the method comprising the steps of:
selecting a first set of agents for assessment;
recording a set of measurable parameters during a first performance of the first set of agents;
determining a plurality of designated performance metrics from a set of performance metrics;
calculating a value for each designated performance metric based on the set of measurable parameters,
calculating a weight for each designated performance metric based at least in part on a second performance of a second set of agents;
calculating an overall performance score as a summation of a set of products of the values for each designated performance metric and the weights for each designated performance metric; and
transmitting the selected overall performance score to an agent in the first set of agents.

2. The computer-readable media of claim 1, wherein the first performance is a live performance.

3. The computer-readable media of claim 1, wherein the second performance is a prior performance.

4. The computer-readable media of claim 1, wherein the first performance and the second performance are not the same performance.

5. The computer-readable media of claim 1, wherein the set of performance metrics includes a performance metric selected from a group consisting of average time per call, average monetary amount collected per unit time, shrinkage, and a forecasted satisfaction rating.

6. The computer-readable media of claim 1, wherein the value of a particular designated performance metric in the plurality of designated performance metrics is equal to a value of a particular measurable parameter in the set of one or more measurable parameters.

7. The computer-readable media of claim 1, wherein the second set of agents is selected based on a shared characteristic with the first set of agents selected from a group consisting of a specialty, a location, a role, and a third performance.

8. The computer-readable media of claim 1, wherein the first set of agents is not the same as the second set of agents.

9. The computer-readable media of claim 1, wherein the step of determining a plurality of designated performance metrics from the set of performance metrics is performed at least in part based on a specialty or a role of the first set of agents.

10. The computer-readable media of claim 1, further including the step of transmitting to the agent the weight calculated for each designated performance metric.

11. The computer-readable media of claim 1, wherein the step of calculating a weight for each designated performance metric based at least in part on a date.

12. The computer-readable media of claim 1,
wherein the second performance is a live performance; and
wherein the step of transmitting the selected overall performance score to the agent in the first set of agents is performed during the second performance.

13. A non-transitory computer readable medium storing computer-executable instructions which, when executed, cause a processor to execute a method of composing feedback, the method comprising the steps of:
selecting an agent for assessment;
determining a plurality of designated performance metrics from a set of performance metrics;
calculating a value for each designated performance metric based on a live performance by the agent;
calculating a weight for each designated performance metric based at least in part on a client being served during the live performance by the agent;
calculating an overall performance score as a function of the calculated values for each designated performance metric and the assigned weight to each designated performance metric; and
transmitting the overall performance score to the agent.

14. The computer-readable media of claim 13, further including the step of transmitting to the agent an indication of a change in the overall performance score over time.

15. The computer-readable media of claim 13, wherein the step of calculating a weight for each designated performance metric is performed based at least in part on a forecasted satisfaction rating of a client being served during the live performance by the agent.

16. The computer-readable media of claim 13, further comprising the steps of:
adjusting a weight calculated for a particular designated performance metric based at least in part on the live performance by the agent;
calculating an updated overall performance score based on the calculated value for the particular designated performance metric and the adjusted weight of the particular designated performance metric; and
transmitting the updated overall performance score to the agent.

17. A non-transitory computer readable medium storing computer-executable instructions which, when executed, cause a processor to execute a method of composing feedback, the method comprising the steps of:
selecting an agent for assessment;
determining a plurality of designated performance metrics from a set of performance metrics;
calculating a value for each designated performance metric based on a live performance by the agent;
determining a set of agents for comparison;
calculating a weight for each designated performance metric based at least in part on a set of prior performances of the set of agents for comparison;
calculating an overall performance score based on the calculated values for each designated performance metric and the assigned weight to each designated performance metric; and
transmitting the overall performance score to the agent for assessment.

18. The computer-readable media of claim 17, wherein the agent for assessment shares a specialty with each agent in the set of agents for comparison.

19. The computer-readable media of claim 17, wherein the agent for assessment shares a role with each agent in the set of agents for comparison.

20. The computer-readable media of claim 17, wherein a client being served during the live performance by the agent for assessment is the same client as was served during the set of prior performances by the set of agents for comparison.
